(19) United States
(12) Patent Application Publication
(10) Pub. No.: US 2026/0212057 A1
(43) Pub. Date: Jul. 23, 2026

(54) GENERATING VISUALIZATIONS OF CONSTRAINED CAD DRAWINGS USING GEOMETRIC VARIATIONS

(71) Applicant: AUTODESK, INC., San Francisco, CA (US)

(72) Inventors: George William FITZMAURICE, Toronto (CA); John Roger THOMPSON, Atlanta, GA (US); Justin Frank MATEJKA, Newmarket (CA); Joseph George LAMBOURNE, London (GB)

(21) Appl. No.: 19/440,486

(22) Filed: Jan. 5, 2026

Related U.S. Application Data
(60) Provisional application No. 63/748,261, filed on Jan. 22, 2025.

(51) Int. Cl. G06F 30/12

(52) U.S. Cl. CPC G06F 30/12

(57) ABSTRACT

A computer-implemented method for visualizing behaviors of constrained computer-aided design (CAD) drawings includes receiving a CAD drawing that includes a plurality of geometric elements; generating, via a constraint solver, a plurality of constrained versions of the CAD drawing, wherein each constrained version of the CAD drawing included in the plurality of constrained versions of the CAD drawing includes a unique combination of one or more geometric constraints; generating a plurality of geometric element variations for a particular constrained version of the CAD drawing included in the plurality of constrained versions of the CAD drawing; and generating and displaying a user interface that includes the plurality of geometric element variations for the particular constrained version of the CAD drawing.

### CROSS-REFERENCE TO RELATED APPLICATIONS

This application claims priority benefit of the United States Provisional Patent Application titled, “TECHNIQUES FOR GENERATING VISUALIZATIONS OF CAD SKETCHES USING GEOMETRIC VARIATIONS,” filed on Jan. 22, 2025, and having Ser. No. 63/748,261. The subject matter of this related application is hereby incorporated herein by reference.

### BACKGROUND

### Field of the Various Embodiments

The various embodiments relate generally to computer science and complex software applications, and, more specifically, to generating visualizations of constrained computer-aided design (CAD) drawings using geometric variations.

### Description of the Related Art

In the discipline of computer-aided design, part of the process of generating a three-dimensional model (3D) is drafting a two-dimensional (2D) sketch or drawing. Generally, a 2D CAD drawing is made up of individual geometric elements, such as lines, arcs, circles, and the like, that are positioned on a 2D surface and defined with specific dimensional values.

To facilitate the generation of a 3D model from a 2D CAD drawing, the CAD drawing is oftentimes parameterized with geometric constraints between individual geometric elements of the CAD drawing. For example, circles or arcs can be constrained to share a common centerpoint, two lines can be constrained to remain orthogonal (or parallel) to each other, and an end point of one line can be constrained to be collocated with an end point of another line. Thus, when suitable geometric constraints are included in a 2D CAD drawing, dimensional values and/or the locations of geometric elements can be modified and the 2D CAD drawing will be automatically scaled in a way that retains the design intent of the model represented by the 2D CAD drawing. As a result, a correctly parameterized 2D CAD drawing can be employed as the basis of a 3D model that does not deform, develop holes or discontinuous lines, or otherwise depart from the design intent when portions of the model are scaled or otherwise modified by the designer.

However, for many designers, applying geometric constraints to a 2D CAD drawing in a way that accurately captures design intent and does not overly constrain the drawing can be difficult. Such difficulty is particularly pronounced for more complex parts or designs. For example, a designer may intend to constrain a 2D CAD drawing so that one component of the design can be scaled longer or shorter in a particular direction while the other elements of the design remain constant in size and do not separate from scaled components. Correctly scaling the 2D CAD drawing for such design intent requires careful selection of multiple geometric constraints, such as limiting the endpoints of specified lines to be collocated with the endpoints of specified lines, certain lines to remain perpendicular to other specified lines, certain points to remain stationary, and the like. Omission of even one of such constraints can lead to a 3D model that is underconstrained, has elements that do not scale correctly, and/or has unwanted distortions or discontinuous lines when one or more dimensions of the design are modified. Further, for the same 2D CAD drawing, a different design intent can require a completely different set of constraints to be applied. As a result, the process of applying suitable geometric constraints to a 2D CAD drawing can be time-consuming and generally requires significant design experience.

To facilitate the design process, automated tools known as “constraint solvers” have been developed that can apply dimensional and geometric constraints to a 2D CAD drawing. For example, various artificial intelligence (AI) based constraint solvers can analyze the geometric elements in a 2D CAD drawing and infer geometrical relationships that need to be maintained between the geometric elements, such as tangency and alignment. Because no single correct configuration of constraints exists for a given 2D CAD drawing, constraint solvers typically provide multiple possible configurations of constraints for a single 2D CAD drawing. The designer can then select a configuration from among the results provided and edit the constraints accordingly.

At least one drawback of the foregoing approach is that the foregoing approach yields elevated error rates in the generated constraint configurations, because each geometric constraint is represented only as an icon or metadata entry and therefore cannot be evaluated for redundant, conflicting, or incomplete constraint relationships. Another drawback of the foregoing approach is that the foregoing approach yields low-quality and unstable constraint outputs. This drawback arises from the large number of mathematically valid constraint configurations that can be generated for a single 2D CAD drawing and from the unpredictable behavior exhibited by many such configurations when dimensional values are modified. Yet another drawback of the foregoing approach is that the foregoing approach results in inefficient use of processing resources, because conventional systems lack automated mechanisms for determining whether a constraint configuration will remain stable under parametric modification and therefore require repeated computation to test configuration behavior. Accordingly, the foregoing approach is associated with various technical drawbacks that hinder accurate assessment and reliable selection of automatically generated constraint configurations.

As the foregoing illustrates, what is needed in the art are more effective techniques for facilitating user evaluation of the behavior of a constraint configuration for a 2D CAD drawing.

### SUMMARY

A computer-implemented method for visualizing behaviors of constrained computer-aided design (CAD) drawings includes receiving a CAD drawing that includes a plurality of geometric elements; generating, via a constraint solver, a plurality of constrained versions of the CAD drawing, wherein each constrained version of the CAD drawing included in the plurality of constrained versions of the CAD drawing includes a unique combination of one or more geometric constraints; generating a plurality of geometric element variations for a particular constrained version of the CAD drawing included in the plurality of constrained versions of the CAD drawing; and generating and displaying a user interface that includes the plurality of geometric element variations for the particular constrained version of the CAD drawing.

At least one technical advantage of the disclosed techniques relative to the prior art is that the disclosed techniques reduce or eliminate errors in generated constraint configurations. This is because the disclosed techniques enable a designer to visually evaluate suggested constraint configurations for a 2D CAD drawing for redundant, conflicting, or incomplete constraint relationships. Because a variety of geometric element variations are displayed simultaneously for one constraint configuration, a designer can quickly determine whether the current constraint configuration for a 2D CAD drawing includes redundant, conflicting, or incomplete constraint relationships and/or departs from the design intent. Thus, even when the designer lacks extensive experience or intuitive knowledge of the effects of different geometric constraints, the suitability of a particular constraint configuration can be easily determined. Another advantage is that a designer can visually avoid selection of low-quality and/or unstable constraint outputs. Thus, the designer can accurately determine whether the current constraint configuration for a 2D CAD drawing includes low-quality and/or unstable constraint outputs without needing to review the effect of each and every geometric constraint included in the constraint configuration. Yet another advantage is that processing resources are more efficiently utilized in selecting a suitable constraint configuration from the plurality of constraint configuration provided by a constraint solver. This is because the disclosed techniques provide automated mechanisms for determining the behavior of constraint configurations when various parameters are modified. Therefore, repeated computation to test the behavior of various configurations can be avoided. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 conceptually illustrates a constrained drawing evaluation system, according to various embodiments.

FIG. 2 sets forth a flowchart of method steps for visualizing behavior of a constrained CAD drawing, according to various embodiments.

FIG. 3 is a conceptual illustration of a 2D CAD drawing, according to various embodiments.

FIG. 4 is a conceptual illustration of a constraint configuration for the 2D CAD drawing of FIG. 3, according to various embodiments.

FIG. 5 is a conceptual illustration of the effect of the constraint configuration of FIG. 4 on a design object when edited by a user, according to various embodiments.

FIG. 6 is a conceptual illustration of another constraint configuration for the 2D CAD drawing of FIG. 3, according to various embodiments.

FIG. 7 is a conceptual illustration of a plurality of geometric element variations displayed for a constraint configuration for a 2D CAD drawing, according to various embodiments.

FIG. 8 is a conceptual illustration of a highlighted geometric element variation of a constraint configuration being displayed with a plurality of unselected geometric element variations of the constraint configuration, according to various embodiments.

FIG. 9 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

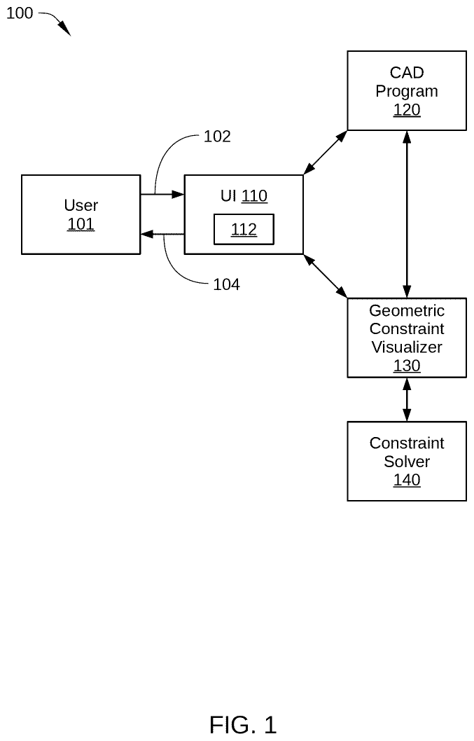

FIG. 1 conceptually illustrates a constrained drawing evaluation system 100, according to various embodiments. Constrained drawing evaluation system 100 is configured to facilitate the selection of a constraint configuration for a particular two-dimensional (2D) computer-aided design (CAD) drawing, for example from a plurality of suggested constraint configurations that are provided by a constraint solver 140. In operation, constrained drawing evaluation system 100 enables a designer or other user 101 to visualize how one particular constraint configuration affects a 2D CAD drawing when applied to the 2D CAD drawing. Specifically, constrained drawing evaluation system 100 displays how the particular constraint configuration allows the 2D CAD drawing to change when various dimension values are modified and/or when the position or orientation of one or more geometric elements in the 2D CAD drawing is modified. Thus, user 101 can visually evaluate whether a specific design intent of a 2D CAD drawing is retained when a particular constraint configuration is applied to the 2D CAD drawing. In the embodiment shown in FIG. 1, constrained drawing evaluation system 100 includes a user interface 110, a CAD program 120, a geometric constraint visualizer 130, and a constraint solver 140.

User interface (UI) 110 enables a user to provide inputs 102 to constrained drawing evaluation system 100 and to view or otherwise receive outputs 104 from constrained drawing evaluation system 100, for example via suitable input/output (I/O) devices. For example, in some embodiments, UI 110 includes a graphical user interface (GUI) that is displayed via a suitable display device. Alternatively, or additionally, in some embodiments, UI 110 includes a command-line interface that enables a user to interact with constrained drawing evaluation system 100 via typed commands and text-based output. In some embodiments, the command-line interface can be a terminal window or another text-based window within a GUI. Thus, in some embodiments, inputs 102 and/or outputs 104 can be graphical and/or text-based.

Inputs 102 can include a 2D CAD drawing of a design object, such as an article of manufacture, a mechanism, a component of a mechanism, and the like. Inputs 102 can further include user selections or other interactions with CAD program 120 and/or geometric constraint visualizer 130, such as the selection of a specific constraint configuration for evaluation or implementation.

The 2D CAD drawing included in inputs 102 comprises multiple individual geometric elements, such as lines, arcs, circles, and the like, which are positioned on a digital 2D surface and defined with specific dimensional values. In some embodiments, the 2D CAD drawing is generated using CAD program 120, while in other embodiments, the 2D CAD drawing is generated using any other suitable software program and is then input by user 101. As part of a design process, the 2D CAD drawing can be employed as the basis of a three-dimensional (3D) model of the design object. However, to ensure that the design intent of the design object in the 2D CAD drawing is retained in the 3D model, suitable geometric constraints can be included in the 2D CAD drawing. Such geometric constraints cause the geometric elements of the 2D CAD drawing to be scaled in a way that retains the design intent of the design object represented by the 2D CAD drawing. Thus, when a designer modifies dimensional values and/or the locations of geometric elements in a suitably constrained 2D CAD drawing, certain components of the design object scale to be longer or shorter and/or undergo rotation as desired. In addition, in a suitably constrained 2D CAD drawing, modification of dimensional values and/or the locations of geometric elements does not cause discontinuous lines to appear in the design object and does not cause unwanted deformation of the design object in a way that violates the design intent of the design object. Some or all of the geometric constraints for the 2D CAD drawing can be determined by constraint solver 140 as described below. In some embodiments, one or more geometric constraints for the 2D CAD drawing can be included manually by user 101, for example as an input 102 to CAD program 120.

Outputs 104 can include a 2D CAD drawing, for example generated via CAD program 120. Outputs 104 can further include one or more constraint configurations for a particular 2D CAD drawing that are generated for the 2D CAD drawing by constraint solver 140. Each constraint configuration is a constrained version of the 2D CAD drawing and includes a unique combination of one or more geometric constraints. In a constrained version of a 2D CAD drawing, modifications are subject to the combination of geometric constraints included in the particular constrained version of the 2D CAD drawing. For example, changes to dimensional values and/or the locations of geometric elements in the constrained version of the 2D CAD drawing are limited by the geometric constraints included in the particular constrained version of the 2D CAD drawing. In some embodiments, each geometric constraint is indicated in a constraint configuration with an icon or glyph. Examples of geometric constraints that can be included in a constraint configuration include tangency of a line to an arc or circle, alignment of one geometric element with another geometric element, perpendicularity of one geometric element to another geometric element, parallelism of one geometric element with another geometric element, colocation of a center point of one arc or circle with a center point of another arc or circle, colocation of a point on one geometric element with a point on another geometric element, symmetry of two or more objects about a line, and the like.

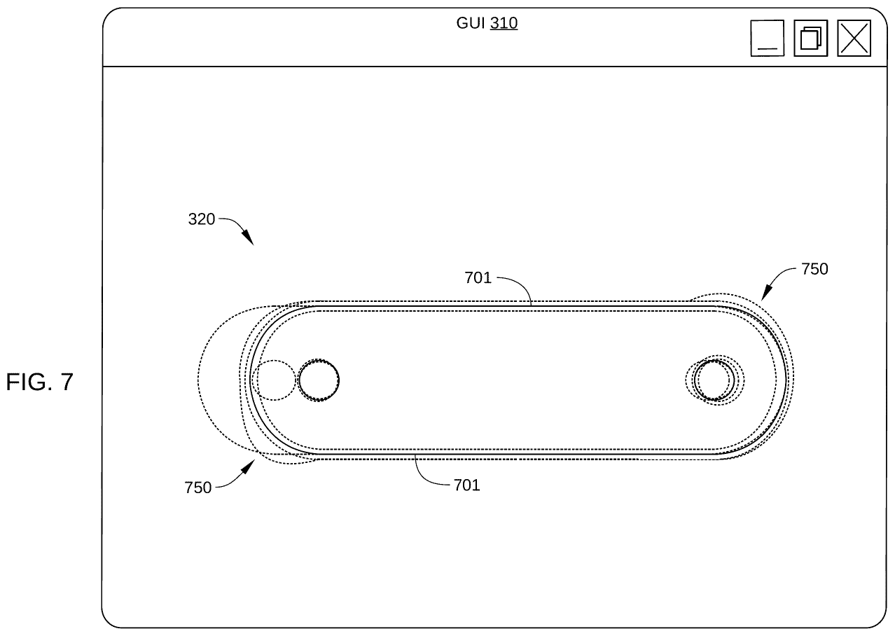

According to various embodiments, outputs 104 can further include a set of multiple geometric variations that are generated by geometric constraint visualizer 130 for a particular constraint configuration. In such embodiments, each geometric variation can be a representation of the geometric elements of a 2D CAD drawing in which a value for at least one dimension or point location associated with a geometric element is changed from an initial value to a scaled value. Such outputs 104 enable a designer to visually evaluate whether a particular constraint configuration correctly captures the design intent for the 2D CAD drawing. Various embodiments of the geometric variations of a particular constraint configuration are described in greater detail below in conjunction with FIG. 7.

CAD program 120 can be any computer-aided design software configured to generate, modify, and analyze 2D drawings and 3D models. Examples of such software include AutoCAD, Fusion, and Inventor, which are available from Autodesk. Constraint solver 140 can be any software application configured to determine geometric constraints for a set of geometric objects included in a 2D CAD drawing. In some embodiments, constraint solver 140 includes a generative artificial intelligence (AI) model. Examples of such constraint solvers include LGS 2D/3D available from Ledas, D-Cubed 2D DCM available from Siemens, and C3D Solver available from C3D Labs. In some embodiments, constraint solver 140 can be implemented as functionality included in CAD program 120.

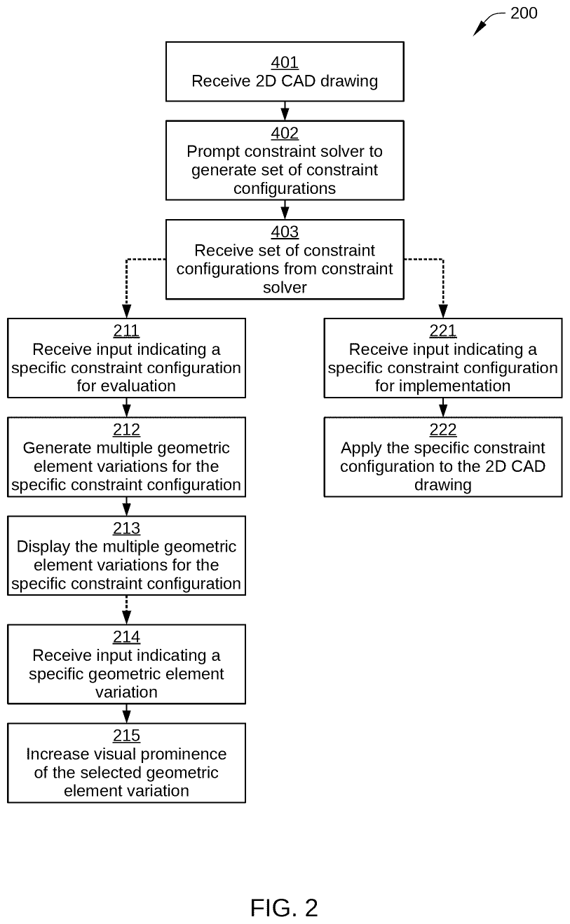

According to various embodiments, geometric constraint visualizer 130 enables user 101 to visually evaluate whether a particular constraint configuration that is applied to a 2D CAD drawing retains a specific design intent of the 2D CAD drawing. In some embodiments, geometric constraint visualizer 130 generates, via constraint solver 140, a plurality of constrained versions of a specific 2D CAD drawing, where each constrained version includes a unique combination of one or more geometric constraints. In some embodiments, geometric constraint visualizer 130 determines and displays a plurality (e.g., 5, 10, or more) of geometric element variations for one particular constrained version of the 2D CAD drawing. In such embodiments, each geometric element variation can be implemented as a representation of the plurality of geometric elements in which a value for at least one dimension included in the 2D CAD drawing is changed from an initial value to a scaled value. Various embodiments of the operations of geometric constraint visualizer 130 are described below in conjunction with FIG. 2.

### Visualization of Constrained CAD Drawing Behavior

FIG. 2 sets forth a flowchart of method steps for visualizing behavior of a constrained CAD drawing, according to various embodiments. Although the method steps are described in conjunction with the system of FIG. 1, persons skilled in the art will understand that any suitable system configured to perform the method steps, in any order, is within the scope of the embodiments.

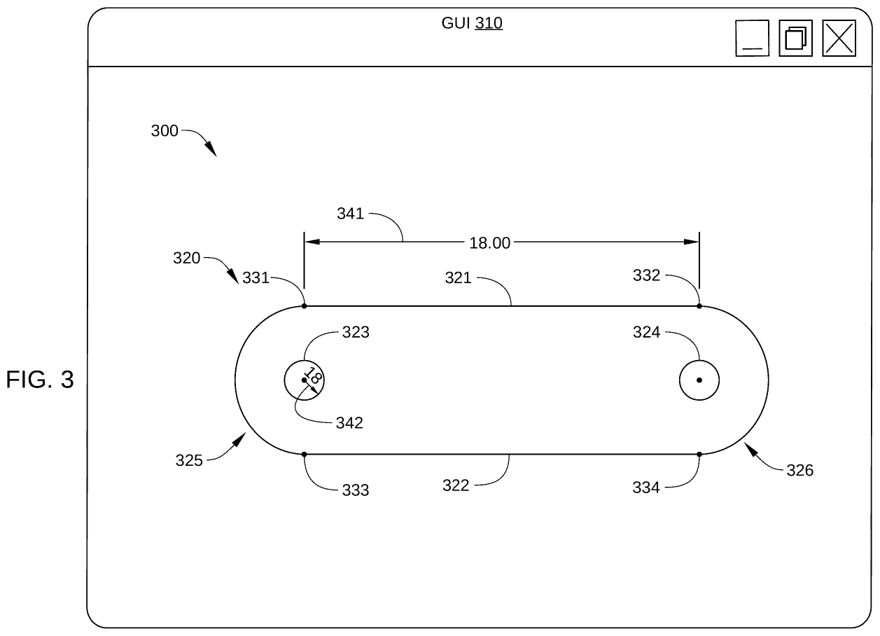

Prior to the method, a 2D CAD drawing is generated, for example via CAD program 120. Alternatively, the 2D CAD drawing can be generated via any other suitable software program. For example, user 101 can generate the 2D CAD drawing by positioning a plurality of individual geometric elements (such as lines, arcs, circles, and the like) on a 2D digital surface. In some embodiments, some or all of the geometric elements are further defined with specific dimensional values input by user 101. One embodiment of a 2D CAD drawing is described below in conjunction with FIG. 3.

FIG. 3 is a conceptual illustration of a 2D CAD drawing 300, according to various embodiments. In FIGS. 3, 2D CAD drawing 300 is shown displayed by a GUI 310, such as a GUI associated with UI 110 of constrained drawing evaluation system 100. 2D CAD drawing 300 includes a design object 320 that includes a plurality of geometric elements. In the embodiment illustrated in FIG. 3, the geometric elements include a top surface 321 represented by a horizontal line, a bottom surface 322 represented by another horizontal line, a first hole 323 represented by a circle, a second hole 324 represented by a second circle, a first end surface 325 represented by a first arc, and a second end surface 326 represented by a second arc. As shown, in the embodiment illustrated in FIG. 3, top surface 321 is connected to first end surface 325 at a point 331 and to second end surface 326 at a point 332, while bottom surface 322 is connected to first end surface 325 at a point 333 and to second end surface 326 at a point 334. Further, a dimension 341 is assigned a value of 160 units for top surface 321 and bottom surface 322, while a radius 342 of first hole 323 and second hole 324 is assigned a value of 18 units. In some embodiments, additional dimensional values can be assigned to other features of design object 320.

Returning to FIG. 2, a computer-implemented method 200 begins at step 201, where constrained drawing evaluation system 100 receives the 2D CAD drawing generated prior to step 201. For example, in some embodiments, user 101 provides the 2D CAD drawing to geometric constraint visualizer 130 via UI 110.

In step 202, geometric constraint visualizer 130 prompts constraint solver 140 to generate a set of multiple constraint configurations for the 2D CAD drawing received in step 201. In some embodiments, the number of constraint configurations to be generated is based on an input 102 from user 101.

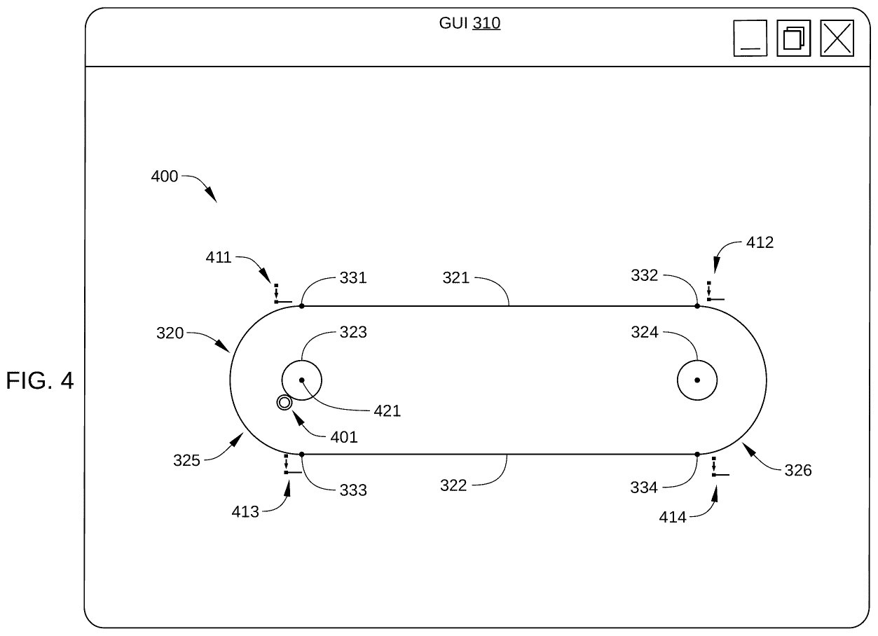

In step 203, geometric constraint visualizer 130 receives the set of constraint configurations generated by constraint solver 140. Each constraint configuration is a constrained version of the 2D CAD drawing that includes a unique combination of one or more geometric constraints. Thus, each constraint configuration received in step 203 is a constrained version of the 2D CAD drawing received in step 201. One embodiment of a constraint configuration for a 2D CAD drawing is described below in conjunction with FIG. 4.

FIG. 4 is a conceptual illustration of a constraint configuration 400 for a 2D CAD drawing, according to various embodiments. Constraint configuration 400 is a constrained version of the 2D CAD drawing received in step 201. For ease of description, in the embodiment illustrated in FIG. 4, the 2D CAD drawing received in step 201 is assumed to be consistent with 2D CAD drawing 300 of FIG. 3. Thus, in the embodiment illustrated in FIG. 4, constraint configuration 400 includes design object 320 with top surface 321, bottom surface 322, first hole 323, second hole 324, first end surface 325, and second end surface 326 positioned as shown. In some embodiments, the 2D CAD drawing can have any other configuration and include more, fewer, or different geometric elements than the geometric elements shown in FIG. 4.

In FIG. 4, constraint configuration 400 further includes a set of multiple geometric constraints, including a concentric constraint 401 and four coincident constraints 411-414. In the embodiment illustrated in FIG. 4, concentric constraint 401 indicates that the circle representing first hole 323 and the arc representing first end surface 325 share a common center point 421. Coincident constraint 411 indicates that top surface 321 and first end surface 325 are coincident at point 331, coincident constraint 412 indicates that top surface 321 and second end surface 326 are coincident at point 332, coincident constraint 413 indicates that bottom surface 322 and first end surface 325 are coincident at point 333, and coincident constraint 414 indicates that bottom surface 322 and second end surface 326 are coincident at point 334.

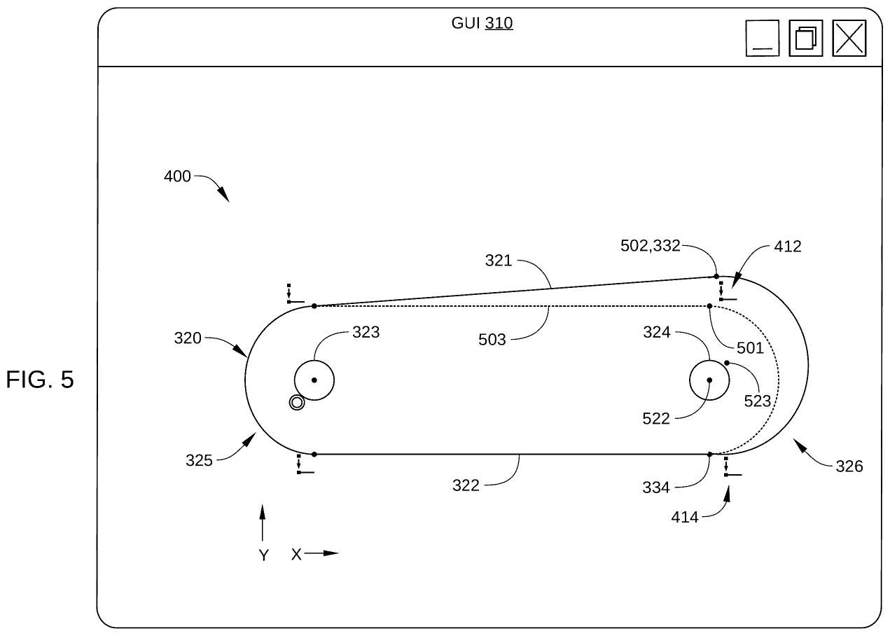

The multiple geometric constraints of constraint configuration 400 define and enforce certain design relationships between the geometric objects (e.g., arc, circles, and lines) of design object 320, such as generating lines that are parallel, perpendicular, or coincident, generating center points of multiple arcs or circles that are coincident, and similar design relationships. Such design relationships are maintained by the geometric constraints of constraint configuration 400 even when the geometric objects included in design object 320 are edited. As noted previously, one or more of the geometric constraints of constraint configuration 400 can be included in constraint configuration 400 by user 101 when initially generating design object 320, while some or all of the geometric constraints of constraint configuration 400 can be included in constraint configuration 400 by geometric constraint visualizer 130 in step 202. The operation of the geometric constraints of constraint configuration 400 is described below in conjunction with FIG. 5.

FIG. 5 is a conceptual illustration of the effect of constraint configuration 400 on design object 320 when edited by user 101, according to various embodiments. In the embodiment illustrated in FIG. 5, user 101 has edited design object 320 by changing a location of point 332 from an initial location 501 to a modified location 502. When point 332 is moved to modified location 502, certain geometric elements of design object 320 are constrained. Specifically, coincident constraint 412 causes the arc representing second end surface 326 to remain connected to top surface 321 at point 332, and coincident constraint 414 causes the arc representing second end surface 326 to remain connected to bottom surface 322 at point 334. Thus, the arc representing second end surface 326 is extended to maintain the coincidence defined by coincident constraint 412. Further, because the circle representing second hole 324 and the arc representing second end surface 326 are not constrained to share a common center point, the circle representing second hole 324 has a center point 522 and the arc representing second end surface 326 has a different center point 523. As a result, the overall shape of design object 320 deforms from the original obround shape 503 (dashed lines) and is no longer symmetric about either an x-axis or a y-axis.

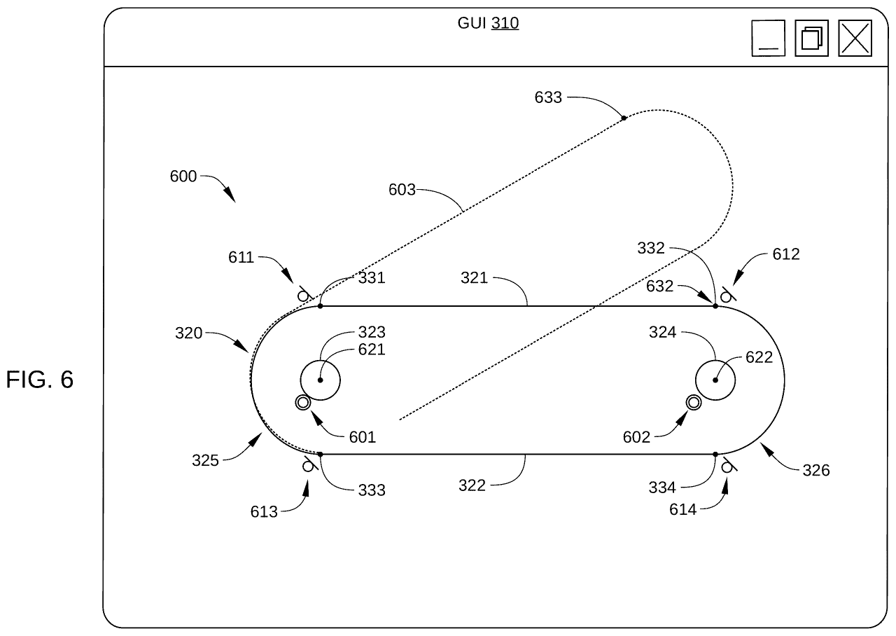

In some instances, the deformation of design object 320 from original obround shape 503 as shown in FIG. 5 follows the design intent for design object 320. In some embodiments, such deformation does not retain the design intent of design object 320. For example, in some instances, a designer can intend for design object 320 to retain an original footprint when rotated and/or translated, so that obround shape 503 is maintained. In such instances, constraint configuration 400 does not retain the design intent of design object 320. An embodiment of a constraint configuration that retains such a design intent for design object 320 is described below in conjunction with FIG. 6.

FIG. 6 is a conceptual illustration of a constraint configuration 600 for a 2D CAD drawing, according to various embodiments. Constraint configuration 600 is a constrained version of the 2D CAD drawing received in step 201 and includes design object 320. Thus, in the embodiment illustrated in FIG. 6, design object 320 includes top surface 321, bottom surface 322, first hole 323, second hole 324, first end surface 325, and second end surface 326 positioned as shown. In contrast to constraint configuration 400 of FIG. 4, constraint configuration 600 includes a different set of geometric constraints that result in a more fully constrained version of design object 320. In the embodiment illustrated in FIG. 6, constraint configuration 600 includes two concentric constraints 601 and 602 and four tangential constraints 611-614. In the embodiment illustrated in FIG. 6, concentric constraint 601 indicates that the circle representing first hole 323 and the arc representing first end surface 325 share a common center point 621, while concentric constraint 602 indicates that the circle representing second hole 324 and the arc representing second end surface 326 share a common center point 622. Tangential constraint 611 indicates that top surface 321 connects tangentially to first end surface 325 at point 331, tangential constraint 612 indicates that top surface 321 connects tangentially to second end surface 326 at point 332, tangential constraint 613 indicates that bottom surface 322 connects tangentially to first end surface 325 at point 333, and tangential constraint 614 indicates that bottom surface 322 connects tangentially to second end surface 326 at point 334. As a result, editing design object 320 by changing a location of point 332 from an initial location 632 to a modified location 633 results in design object 320 maintaining an original obround shape and thus rotating about center point 621 of first hole 323 to modified location 603 (dashed lines).

Returning to FIG. 2, in step 204, geometric constraint visualizer 130 displays some or all of constraint configurations received in step 203. Each constraint configuration is a constrained version of the 2D CAD drawing that includes a unique combination of one or more geometric constraints. For example, constraint configuration 400 of FIG. 4 and constraint configuration 600 of FIG. 6 can be included in the set of constraint configurations received in step 203 and displayed in step 204.

In step 211, geometric constraint visualizer 130 receives an input indicating a specific constraint configuration for evaluation. For example, in some embodiments, an input 102 (shown in FIG. 1) by user 101 selects a particular constraint configuration for evaluation by user 101. The specific constraint configuration is selected from the set of constraint configurations received in step 203.

In step 212, geometric constraint visualizer 130 generates multiple geometric element variations for the constraint configuration indicated in step 211. Each geometric element variation generated for the indicated constrained version can be a representation of the geometric elements of design object 320 in which a value for at least one dimension associated with one particular geometric element of design object 320 is changed from an initial value to a scaled value. In some embodiments, geometric constraint visualizer 130 generates a geometric element variation by selecting at least one dimension associated with one particular geometric element in the constraint configuration, determining a scaled value for the at least one dimension, and rendering a representation of the constraint configuration in which an initial value of the at least one dimension is changed to the scaled value. It is noted that geometric constraint visualizer 130 renders the representation of the constraint configuration by applying the scaled value for the at least one dimension and the geometric constraints associated with the constraint configuration. Thus, each geometric element variation takes into account the constraints associated with the indicated constraint configuration.

In some embodiments, the dimension associated with the particular geometric element can be one of a length of the particular geometric element, a radius of the particular geometric element, a vertical position within the indicated constraint configuration of a point on the particular geometric element, or a horizontal position within the indicated constraint configuration of the point on the particular geometric element. For example, one geometric element variation can be a representation of design object 320 after being edited so that a radius of a geometric element is increased or decreased slightly from an initial value. When displayed to user 101, the geometric element variation enables user 101 to visually evaluate whether unwanted deformation of design object 320 occurs when the radius is changed in value. Similarly, in another example, a geometric element variation can be a representation of design object 320 after being edited so that a horizontal and/or vertical location of a point associated with a geometric element is increased or decreased slightly from an initial value. When displayed to user 101, the geometric element variation enables user 101 to visually evaluate whether unwanted deformation of design object 320 occurs when a particular point of a geometric element is slightly repositioned.

In step 213, geometric constraint visualizer 130 displays (or causes to be displayed) the multiple geometric element variations generated for the constraint configuration indicated in step 211. Display of the geometric element variations is described below in conjunction with FIG. 7.

FIG. 7 is a conceptual illustration of a plurality of geometric element variations 750 displayed for a constraint configuration, according to various embodiments. As shown, an initial state 701 of a design object is shown as well as a plurality of geometric element variations 750 (dashed lines). Initial state 701 of the design object corresponds to the design object (e.g., design object 320 of FIG. 3) having the dimensions and point locations indicated in the 2D CAD drawing received in step 201. Each geometric element variation represents an instance of one or more dimensions or point locations being modified from an initial value. In the embodiment illustrated in FIG. 7, geometric element variations 750 are displayed as “ghost” sketches that are visually less prominent than initial state 701 of the design object. For example, geometric element variations 750 can be displayed with lighter-weight lines and/or with a less visible color. In some embodiments, a user of a CAD system can more readily visualize the plurality of geometric element variations 750 simultaneously and thereby gain insight into how the constraint configuration is affected by changes to dimension parameters.

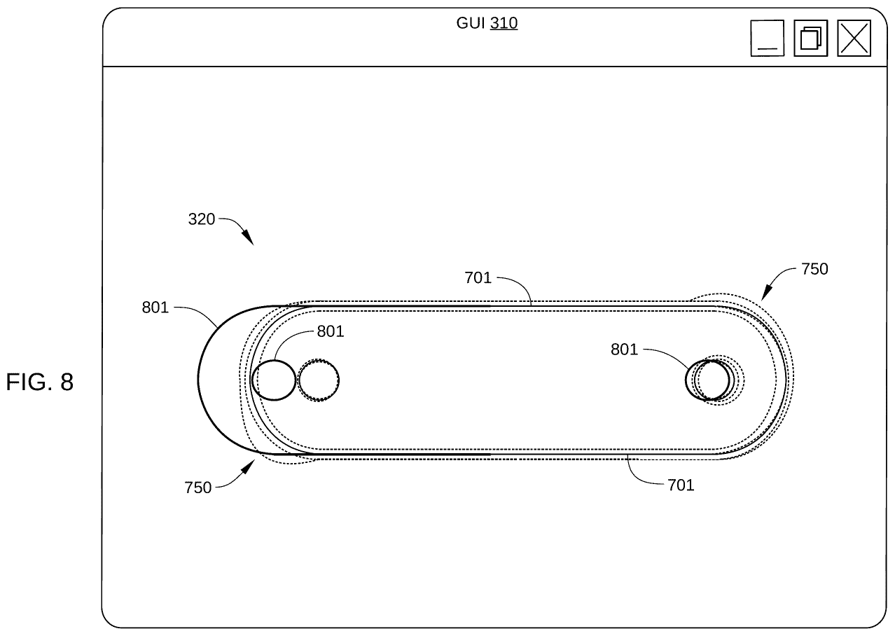

Returning to FIG. 2, in step 214, geometric constraint visualizer 130 receives an input indicating a specific geometric element variation to be highlighted. For example, in some embodiments, an input 102 (shown in FIG. 1) by user 101 indicates a particular geometric element variation to be highlighted. In some embodiments, the input can be hovering of a cursor on a particular geometric element variation and/or clicking on a particular geometric element variation. In step 215, geometric constraint visualizer 130 increases the visual prominence of the specific geometric element variation indicated in step 214. The results of indicating the specific geometric element variation in the constraint configuration are described below in conjunction with FIG. 8.

FIG. 8 is a conceptual illustration of a highlighted geometric element variation being displayed with a plurality of unselected geometric element variations 750, according to various embodiments. As shown, initial state 701 of a design object is shown as well as a plurality of geometric element variations 750 (dashed lines). As noted above, each geometric element variation is a representation of a different instance of the design object after one or more dimensions or point locations are modified. In the embodiment illustrated in FIG. 8, the unselected geometric element variations 750 are depicted as “ghost” sketches that are visually less prominent than a highlighted geometric element variation 801. For example, unselected geometric element variations 750 can be displayed with lighter-weight lines and/or with a less visible color than highlighted geometric element variation 801.

In some embodiments, highlighted geometric element variation 801 is rendered more visually prominent in response to a cursor being hovered over a particular geometric element variation. Alternatively, or additionally, in some embodiments, highlighted geometric element variation 801 is highlighted in response to being selected by a user, for example by being clicked on or otherwise selected.

Highlighted geometric element variation 801 can be rendered more visually prominent in various ways. For example, in some embodiments, highlighted geometric element variation 801 can be displayed with heavier-weight lines and/or with a more visible color than unselected geometric element variations 750. Further, in such embodiments, the visualization of highlighted geometric element variation 801 can be color-encoded to indicate a degree to which each geometric element of the design object changes position and/or is distorted in comparison to initial state 701. Alternatively, or additionally, in some embodiments, highlighted geometric element variation 801 can be animated to be more visually prominent than unselected geometric element variations 750. In such embodiments, when a user selects a particular geometric element variation (e.g., by hovering a cursor over the particular geometric element variation), the curves, lines, points, constraints, and/or dimensions of the selected geometric element variation animate. For example, such animation can include flashing, continuously varying color, continuously varying line thickness, or similar animation.

In some embodiments, the effects of modifying a value for a specific dimension of the design object can be illustrated. In such embodiments, when a designer or other user indicates a particular dimension (e.g., by hovering a cursor on or otherwise selecting the particular dimension), geometric constraint visualizer 130 displays a geometric element variation in which the selected dimension varies about an initial value to one or more scaled values. In such embodiments, geometric constraint visualizer 130 can animate elements of the design object that are affected by the change in the dimension, including geometric elements, points, and/or geometric constraints.

The display of a constraint configuration as described above with unselected geometric element variations 750 and highlighted geometric element variation 801 provides a user with an indication of the geometric freedom of individual geometric elements. Further, taken together, unselected geometric element variations 750 provide a visual overview of the design possibilities of the currently considered constraint configuration. As a result, a designer can readily determine which parts of the design object will scale uniformly when edited, whether 90° angles are maintained in the design object when edited, and whether certain portions of the design object retain an initial shape when relocated and/or certain dimensions are modified. Thus, evaluation of highlighted geometric element variation 801 and unselected geometric element variations 750 enables a designer or other user to determine whether the currently considered constraint configuration is suitable for use in a 3D model of the design object.

In the embodiments described above, geometric constraint visualizer 130 displays a single constraint configuration and the associated unselected geometric element variations 750. In some embodiments, geometric constraint visualizer 130 displays multiple constraint configurations for evaluation. Thus, in such embodiments, a designer or other user can evaluate the multiple constraint configurations simultaneously.

Returning to FIG. 2, in step 221, geometric constraint visualizer 130 receives an input indicating a specific constraint configuration for implementation. For example, in some embodiments, an input 102 (shown in FIG. 1) by user 101 selects a particular constraint configuration that is to be implemented in the 2D CAD drawing received in step 201. The specific constraint configuration is selected from the set of constraint configurations received in step 203. In step 222, geometric constraint visualizer 130 applies the specific constraint configuration indicated in step 221 to the 2D CAD drawing received in step 201.

### Exemplary Computing Device

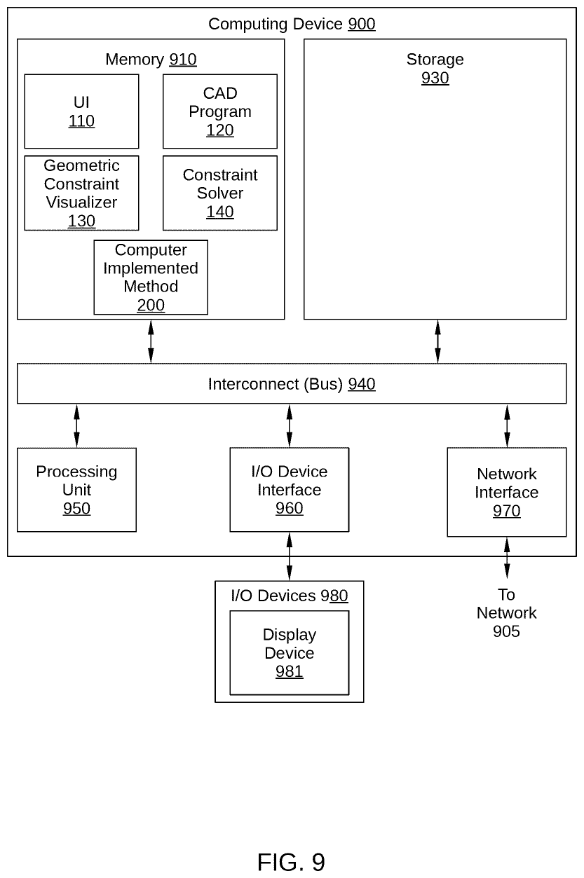

FIG. 9 is a block diagram of a computing device 900 configured to implement one or more aspects of the various embodiments. Computing device 900 may be a desktop computer, a laptop computer, a tablet computer, or any other type of computing device configured to receive input, process data, generate control signals, and display images. Computing device 900 is configured to perform operations associated with UI 110, CAD program 120, geometric constraint visualizer 130, constraint solver 140, and/or computer-implemented method 200, and/or other suitable software applications, which can reside in a memory 910. It is noted that the computing device described herein is illustrative and that any other technically feasible configurations fall within the scope of the present disclosure.

As shown, computing device 900 includes, without limitation, an interconnect (bus) 940 that connects a processing unit 950, an input/output (I/O) device interface 960 coupled to input/output (I/O) devices 980, memory 910, a storage 930, and a network interface 970. Processing unit 950 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 950 may be any technically feasible hardware unit capable of processing data and/or executing software applications, including processes associated with UI 110, CAD program 120, geometric constraint visualizer 130, constraint solver 140, and/or computer-implemented method 200. Further, in the context of the present disclosure, the computing elements shown in computing device 900 may correspond to a physical computing system (e.g., a system in a data center) or may be a virtual computing instance executing within a computing cloud.

I/O devices 980 may include devices capable of providing input, such as a keyboard, a mouse, a touch-sensitive screen, and so forth, as well as devices capable of providing output, such as a display device 981. Additionally, I/O devices 980 may include devices capable of both receiving input and providing output, such as a touchscreen, a universal serial bus (USB) port, and so forth. I/O devices 980 may be configured to receive various types of input from an end-user of computing device 900 and to also provide various types of output to the end-user of computing device 900, such as one or more graphical user interfaces (GUI), displayed digital images, and/or digital videos. In some embodiments, one or more of I/O devices 980 are configured to couple computing device 900 to a network 905.

Memory 910 may include a random access memory (RAM) module, a flash memory unit, or any other type of memory unit or combination thereof. Processing unit 950, I/O device interface 960, and network interface 970 are configured to read data from and write data to memory 910. Memory 910 includes various software programs that can be executed by processing unit 950 and application data associated with said software programs, including UI 110, CAD program 120, geometric constraint visualizer 130, constraint solver 140, and/or computer-implemented method 200.

In sum, the various embodiments described herein prompt a constraint solver for a plurality of constraint configurations that can be applied to a specific 2D CAD drawing. For each constraint configuration, a plurality of geometric element variations is determined, where each geometric element variation represents geometric elements of the specific 2D CAD drawing in which a value for at least one dimension or point location associated with a geometric element is changed from an initial value to a scaled value. When displayed together, the geometric element variations for a particular constraint configuration provide a visual overview of the design possibilities of the particular constraint configuration.

At least one technical advantage of the disclosed techniques relative to the prior art is that the disclosed techniques reduce or eliminate errors in generated constraint configurations. This is because the disclosed techniques enable a designer to visually evaluate suggested constraint configurations for a 2D CAD drawing for redundant, conflicting, or incomplete constraint relationships. Because a variety of geometric element variations are displayed simultaneously for one constraint configuration, a designer can quickly determine whether the current constraint configuration for a 2D CAD drawing includes redundant, conflicting, or incomplete constraint relationships and/or departs from the design intent. Thus, even when the designer lacks extensive experience or intuitive knowledge of the effects of different geometric constraints, the suitability of a particular constraint configuration can be easily determined. Another advantage is that a designer can visually avoid selection of low-quality and/or unstable constraint outputs. Thus, the designer can accurately determine whether the current constraint configuration for a 2D CAD drawing includes low-quality and/or unstable constraint outputs without needing to review the effect of each and every geometric constraint included in the constraint configuration. Yet another advantage is that processing resources are more efficiently utilized in selecting a suitable constraint configuration from the plurality of constraint configuration provided by a constraint solver. This is because the disclosed techniques provide automated mechanisms for determining the behavior of constraint configurations will remain stable when various parameters are modified. Therefore, repeated computation to test the behavior of various configurations can be avoided. These technical advantages provide one or more technological advancements over prior art approaches.

1. In some embodiments, a computer-implemented method for visualizing behaviors of constrained computer-aided design (CAD) drawings includes: receiving a CAD drawing that includes a plurality of geometric elements; generating, via a constraint solver, a plurality of constrained versions of the CAD drawing, wherein each constrained version of the CAD drawing included in the plurality of constrained versions of the CAD drawing includes a unique combination of one or more geometric constraints; generating a plurality of geometric element variations for a particular constrained version of the CAD drawing included in the plurality of constrained versions of the CAD drawing; and generating and displaying a user interface that includes the plurality of geometric element variations for the particular constrained version of the CAD drawing.

2. The computer-implemented method of clause 1, wherein each geometric element variation included in the plurality of geometric element variations for the particular constrained version of the CAD drawing comprises a representation of the plurality of geometric elements in which a value for at least one dimension associated with a particular geometric element included in the plurality of geometric elements is changed from an initial value to a scaled value.

3. The computer-implemented method of clauses 1 or 2, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

4. The computer-implemented method of any of clauses 1-3, wherein each constrained version of the CAD drawing included in the plurality of constrained versions of the CAD drawing comprises a partially constrained version of the CAD drawing.

5. The computer-implemented method of any of clauses 1-4, wherein generating a geometric element variation included in the plurality of geometric element variations for the particular constrained version of the CAD drawing comprises: selecting at least one dimension associated with a particular geometric element included in the plurality of geometric elements of the CAD drawing; determining a scaled value for the at least one dimension; and rendering a representation of the CAD drawing in which an initial value of the at least one dimension is changed to the scaled value.

6. The computer-implemented method of any of clauses 1-5, wherein rendering the representation of the CAD drawing comprises applying the scaled value for the at least one dimension to the CAD drawing.

7. The computer-implemented method of any of clauses 1-6, wherein rendering the representation of the CAD drawing comprises applying the unique combination of one or more geometric constraints associated with the particular constrained version of the CAD drawing to the CAD drawing.

8. The computer-implemented method of any of clauses 1-7, wherein the one or more geometric constraints included in a given constrained version of the CAD drawing is applied to at least one geometric element included in the plurality of geometric elements.

9. The computer-implemented method of any of clauses 1-8, wherein the one or more geometric constraints included in a given constrained version of the CAD drawing indicates at least one of a relationship between two geometric elements included in the plurality of geometric elements or an orientation of a particular geometric element included in the plurality of geometric elements.

10. The computer-implemented method of any of clauses 1-9, further comprising prompting the constraint solver to generate a plurality of instances of a constrained version of the CAD drawing.

11. The computer-implemented method of any of clauses 1-10, further comprising displaying a representation of a modified 3D model within the user interface, wherein the modified 3D model is based on the particular constrained version of the CAD drawing.

12. The computer-implemented method of any of clauses 1-11, further comprising: receiving an input indicating a specific dimension of the CAD drawing; determining a scaled value for the specific dimension; and rendering, within the user interface, a representation of the CAD drawing in which an initial value of the specific dimension is changed to the scaled value.
13. In some embodiments, a non-transitory computer readable medium includes a set of instructions which, in response to execution by a processor of a computer system, cause the processor to perform the steps of: receiving a CAD drawing that includes a plurality of geometric elements; generating, via a constraint solver, a plurality of constrained versions of the CAD drawing, wherein each constrained version of the CAD drawing included in the plurality of constrained versions of the CAD drawing includes a unique combination of one or more geometric constraints; generating a plurality of geometric element variations for a particular constrained version of the CAD drawing included in the plurality of constrained versions of the CAD drawing; and generating and displaying a user interface that includes the plurality of geometric element variations for the particular constrained version of the CAD drawing.

14. The non-transitory computer readable medium of clause 13, wherein each geometric element variation included in the plurality of geometric element variations for the particular constrained version of the CAD drawing comprises a representation of the plurality of geometric elements in which a value for at least one dimension associated with a particular geometric element included in the plurality of geometric elements is changed from an initial value to a scaled value.

15. The non-transitory computer readable medium of clauses 13 or 14, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

16. The non-transitory computer readable medium of any of clauses 13-15, wherein each constrained version of the CAD drawing included in the plurality of constrained versions of the CAD drawing comprises a partially constrained version of the CAD drawing.

17. The non-transitory computer readable medium of any of clauses 13-16, wherein generating a geometric element variation included in the plurality of geometric element variations for the particular constrained version of the CAD drawing comprises: selecting at least one dimension associated with a particular geometric element included in the plurality of geometric elements of the CAD drawing; determining a scaled value for the at least one dimension; and rendering a representation of the CAD drawing in which an initial value of the at least one dimension is changed to the scaled value.

18. The non-transitory computer readable medium of any of clauses 13-17, wherein rendering the representation of the CAD drawing comprises applying the scaled value for the at least one dimension to the CAD drawing.

19. The non-transitory computer readable medium of any of clauses 13-18, wherein rendering the representation of the CAD drawing comprises applying the unique combination of one or more geometric constraints associated with the particular constrained version of the CAD drawing to the CAD drawing.

20. In some embodiments, a system includes: a memory that stores instructions; and a processor that is communicatively coupled to the memory and is configured to, when executing the instructions, perform the steps of: receiving a CAD drawing that includes a plurality of geometric elements; generating, via a constraint solver, a plurality of constrained versions of the CAD drawing, wherein each constrained version of the CAD drawing included in the plurality of constrained versions of the CAD drawing includes a unique combination of one or more geometric constraints; generating a plurality of geometric element variations for a particular constrained version of the CAD drawing included in the plurality of constrained versions of the CAD drawing; and generating and displaying a user interface that includes the plurality of geometric element variations for the particular constrained version of the CAD drawing.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for visualizing behaviors of constrained computer-aided design (CAD) drawings, the method comprising:
receiving a CAD drawing that includes a plurality of geometric elements;
generating, via a constraint solver, a plurality of constrained versions of the CAD drawing, wherein each constrained version of the CAD drawing included in the plurality of constrained versions of the CAD drawing includes a unique combination of one or more geometric constraints;
generating a plurality of geometric element variations for a particular constrained version of the CAD drawing included in the plurality of constrained versions of the CAD drawing; and
generating and displaying a user interface that includes the plurality of geometric element variations for the particular constrained version of the CAD drawing.

2. The computer-implemented method of claim 1, wherein each geometric element variation included in the plurality of geometric element variations for the particular constrained version of the CAD drawing comprises a representation of the plurality of geometric elements in which a value for at least one dimension associated with a particular geometric element included in the plurality of geometric elements is changed from an initial value to a scaled value.

3. The computer-implemented method of claim 2, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

4. The computer-implemented method of claim 1, wherein each constrained version of the CAD drawing included in the plurality of constrained versions of the CAD drawing comprises a partially constrained version of the CAD drawing.

5. The computer-implemented method of claim 1, wherein generating a geometric element variation included in the plurality of geometric element variations for the particular constrained version of the CAD drawing comprises:
selecting at least one dimension associated with a particular geometric element included in the plurality of geometric elements of the CAD drawing;
determining a scaled value for the at least one dimension; and
rendering a representation of the CAD drawing in which an initial value of the at least one dimension is changed to the scaled value.

6. The computer-implemented method of claim 5, wherein rendering the representation of the CAD drawing comprises applying the scaled value for the at least one dimension to the CAD drawing.

7. The computer-implemented method of claim 5, wherein rendering the representation of the CAD drawing comprises applying the unique combination of one or more geometric constraints associated with the particular constrained version of the CAD drawing to the CAD drawing.

8. The computer-implemented method of claim 1, wherein the one or more geometric constraints included in a given constrained version of the CAD drawing is applied to at least one geometric element included in the plurality of geometric elements.

9. The computer-implemented method of claim 1, wherein the one or more geometric constraints included in a given constrained version of the CAD drawing indicates at least one of a relationship between two geometric elements included in the plurality of geometric elements or an orientation of a particular geometric element included in the plurality of geometric elements.

10. The computer-implemented method of claim 1, further comprising prompting the constraint solver to generate a plurality of instances of a constrained version of the CAD drawing.

11. The computer-implemented method of claim 1, further comprising displaying a representation of a modified 3D model within the user interface, wherein the modified 3D model is based on the particular constrained version of the CAD drawing.

12. The computer-implemented method of claim 1, further comprising:
receiving an input indicating a specific dimension of the CAD drawing;
determining a scaled value for the specific dimension; and
rendering, within the user interface, a representation of the CAD drawing in which an initial value of the specific dimension is changed to the scaled value.

13. A non-transitory computer readable medium that includes a set of instructions which, in response to execution by a processor of a computer system, cause the processor to perform the steps of:
receiving a CAD drawing that includes a plurality of geometric elements;
generating, via a constraint solver, a plurality of constrained versions of the CAD drawing, wherein each constrained version of the CAD drawing included in the plurality of constrained versions of the CAD drawing includes a unique combination of one or more geometric constraints;
generating a plurality of geometric element variations for a particular constrained version of the CAD drawing included in the plurality of constrained versions of the CAD drawing; and
generating and displaying a user interface that includes the plurality of geometric element variations for the particular constrained version of the CAD drawing.

14. The non-transitory computer readable medium of claim 13, wherein each geometric element variation included in the plurality of geometric element variations for the particular constrained version of the CAD drawing comprises a representation of the plurality of geometric elements in which a value for at least one dimension associated with a particular geometric element included in the plurality of geometric elements is changed from an initial value to a scaled value.

15. The non-transitory computer readable medium of claim 14, wherein the at least one dimension associated with the particular geometric element comprises at least one of a length of the particular geometric element, a radius of the particular geometric element, a vertical position within the CAD drawing of a point on the particular geometric element, or a horizontal position within the CAD drawing of the point on the particular geometric element.

16. The non-transitory computer readable medium of claim 13, wherein each constrained version of the CAD drawing included in the plurality of constrained versions of the CAD drawing comprises a partially constrained version of the CAD drawing.

17. The non-transitory computer readable medium of claim 13, wherein generating a geometric element variation included in the plurality of geometric element variations for the particular constrained version of the CAD drawing comprises:
selecting at least one dimension associated with a particular geometric element included in the plurality of geometric elements of the CAD drawing;
determining a scaled value for the at least one dimension; and
rendering a representation of the CAD drawing in which an initial value of the at least one dimension is changed to the scaled value.

18. The non-transitory computer readable medium of claim 17, wherein rendering the representation of the CAD drawing comprises applying the scaled value for the at least one dimension to the CAD drawing.

19. The non-transitory computer readable medium of claim 17, wherein rendering the representation of the CAD drawing comprises applying the unique combination of one or more geometric constraints associated with the particular constrained version of the CAD drawing to the CAD drawing.

20. A system, comprising:
a memory that stores instructions; and
a processor that is communicatively coupled to the memory and is configured to, when executing the instructions, perform the steps of:
receiving a CAD drawing that includes a plurality of geometric elements;
generating, via a constraint solver, a plurality of constrained versions of the CAD drawing, wherein each constrained version of the CAD drawing included in the plurality of constrained versions of the CAD drawing includes a unique combination of one or more geometric constraints;
generating a plurality of geometric element variations for a particular constrained version of the CAD drawing included in the plurality of constrained versions of the CAD drawing; and
generating and displaying a user interface that includes the plurality of geometric element variations for the particular constrained version of the CAD drawing.
